(19) United States
(12) Patent Application Publication
(10) Pub. No.: US 2007/0283062 A1
(43) Pub. Date: Dec. 6, 2007

(54) BUS CONTROL SYSTEM

(75) Inventors: Junkei Sato, Sendai-shi (JP); Yuji Mizuishi, Sendai-shi (JP)

Correspondence Address: FREESCALE SEMICONDUCTOR, INC.;LAW DEPARTMENT, 7700 WEST PARMER LANE MD:TX32/PL02, AUSTIN, TX, 78729, US

(73) Assignee: Freescale Semiconductor, Inc., Austin, TX (US)

(21) Appl. No.: 11/696,734

(22) Filed: Apr. 5, 2007

(30) Foreign Application Priority Data
Apr. 19, 2006 (JP) 2006-115773

(51) Int. Cl. G06F 13/00

(52) U.S. Cl. 710/107

(57) ABSTRACT

A bus control system that reduces power consumption with a relatively simple structure. Load input signals are respectively provided to input capture registers. A free running counter provides each input capture register with a counter signal through a timer bus. A latch circuit is arranged in the timer bus. Capture conditions of each load input signal is input to an OR circuit connected to the latch circuit. When the capture conditions of at least one load input signal are satisfied, the latch circuit provides each input capture register with a counter signal.

### BACKGROUND OF THE INVENTION

The present invention relates to a bus control system for processing a signal that is provided through a bus.

Various types of buses, which function as paths for transferring commands and data between computer elements, are laid out on an integrated circuit. The buses include an address bus and a data bus. The address bus transfers addresses indicating locations for storing data. The data bus transfers information that is actually processed.

Japanese Laid-Open Patent Publication Nos. 2003-120411 (page 1) and 8-258694 (FIG. 3) each describe a system for performing various measurements and controls using signals provided through a timer bus. As shown in FIG. 6, each system is provided with a signal through a timer bus and uses input capture circuits. The timer bus is connected to a free running counter 120, which provides input capture registers 111 to 114 with a counter signal through the timer bus. When capture conditions of load input signals 101 to 104 are satisfied, the input capture registers 111 to 114 retrieve the present counter signal.

Japanese Laid-Open Patent Publication Nos. 8-106446 (FIG. 8) and 2001-67861 (page 1) describe an address decoder connected to an address bus. The address decoder analyzes the value of a designated address and generates a signal for selecting a proper storage location in a memory. As shown in FIG. 7, with such an address decoder, a bus master 160 performs DMA transfer to transmit address signals and write data signals so as to write data to the modules 131 to 134. In this case, the address decoder 140 transmits the write data signal by selecting modules using the upper rank bits of the address signal.

An integrated circuit (IC) is used in various types of applications. This has increased demands related with the system performance. To cope with such demands, the frequency of a system bus must be increased and the width of a bus must be increased. However, this significantly increases power consumption in a bus. Particularly, an address bus and a data bus that connect a large capacity memory with a CPU have a larger number of bits than other types of signal lines. Further, the address bus and data bus tend to have a longer line length. Thus, the switching of a signal would generally result in more power consumption than other signal lines. At the same time, the demand for reducing power consumption in ICs has become stronger. Accordingly, the key for bus control being applied to household appliances and mobile products-would be in whether power consumption can be reduced while maintaining high performance.

However, in the timer bus shown in FIG. 6, the input capture registers are all connected to the timer bus. Thus, the timer bus constantly provides all of the input capture registers with a signal. For example, even if the capture conditions of the load input signals 102 to 104 are not satisfied, the input capture registers 111 to 114 are all provided with a counter signal. Therefore, in the input capture registers 112 to 114 that are not operating, the switching of the counter signal is performed for each clock. This increases power consumption.

In the bus system of FIG. 7, the address decoder 140 is connected to each bus. Further, the modules 131 to 134 are all provided with the address signal and the write data signal. As a result, when only one of the modules is activated, the signal is switched for each clock in the bus connected to each module. The power consumption would be reduced by stopping the transmission of a signal to a module that is not operating by using a DFF to partition the modules. However, this would lower the performance of the system bus. When the performance is lowered in such a manner, the bus system cannot be applied to a product that requires a high performance.

### SUMMARY OF THE INVENTION

The present invention provides a bus control system for lowering power consumption with a relatively simple structure.

One aspect of the present invention is a bus control system for performing gate control. The bus control system includes a bus for connecting a signal providing means with a unit, a detector for detecting an activated state of the unit, and a latch arranged in the bus between the signal providing means and the unit. The bus control system performs gate control on the latch based on the activated state of the unit detected by the detector.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a block diagram of a circuit according to a first embodiment of the present invention;

FIG. 2 is a timing chart of the first embodiment;

FIG. 3 is a block diagram of a circuit according to a second embodiment of the present invention;

FIG. 4 is an address map of the second embodiment;

FIG. 5 is a block diagram of a prior art circuit;

FIG. 6 is a block diagram of a prior art circuit; and

FIG. 7 is a block diagram of a prior art circuit.

### DETAILED DESCRIPTION OF THE PREFERRED EMBODIMENTS

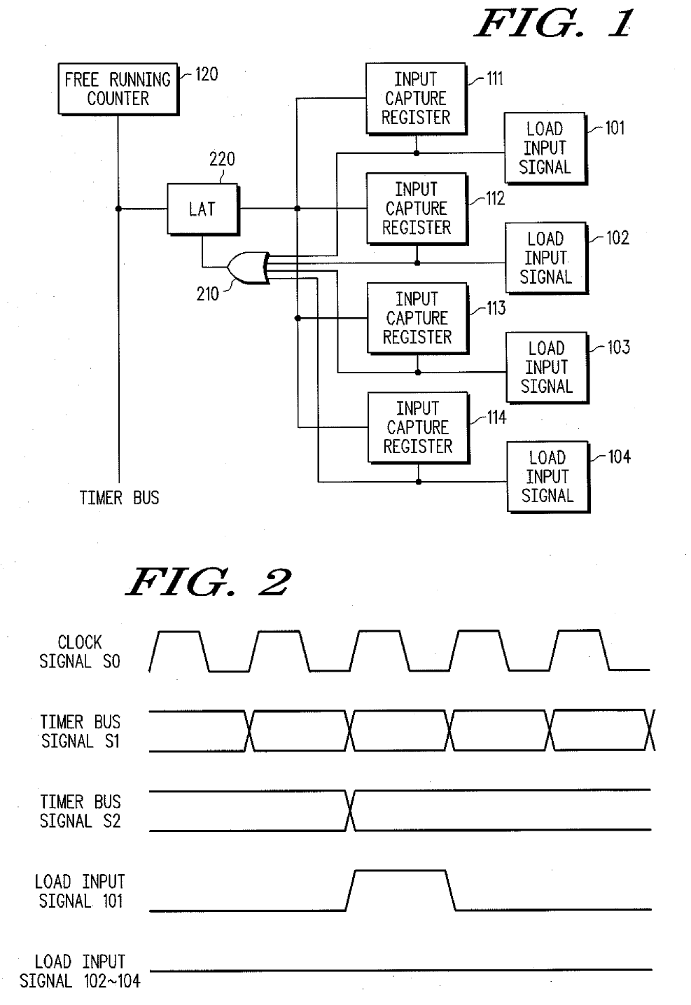

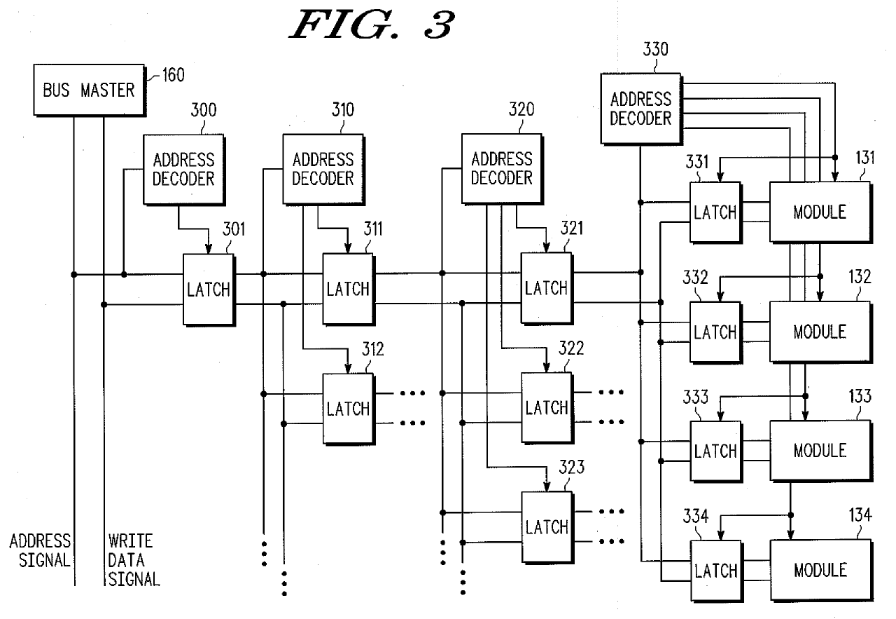

A first embodiment of the present invention will now be discussed with reference to FIGS. 1 and 2. In the first embodiment, a bus control system is applied to a timer bus.

In the first embodiment, input capture registers 111 to 114 are respectively connected to units for transmitting load input signals 101 to 104.

When capture conditions for each of the load input signals 101 to 104 are satisfied (activated state), each input capture register 111 to 114 retrieves a counter signal generated by a free running counter 120, which serves as a signal providing means. The free running counter 120 generates a counter signal based on a clock signal. Then, the free running counter 120 provides the input capture registers 111 to 114 with the counter signal through the timer bus.

A latch circuit 220, which serves as a latch means, is arranged in the timer bus between the free running counter 120 and the input capture registers 111 to 114. The latch circuit 220 latches the counter signal transmitted through the timer bus.

An OR circuit 210, which serves as a detector or detection means, is connected to the latch circuit 220. The capture conditions of the load input signals 101 to 104 are input to the OR circuit 210. When the capture conditions of at least one of the load input signal are satisfied, the latch circuit 220 provides each of the input capture registers 111 to 114 with the counter signal. When the capture conditions of all of the load input signals 110 to 114 are not satisfied, the latch circuit 220 holds the original counter signal and provides each of the input capture registers 111 to 114 with this counter signal.

The timing chart of FIG. 2 shows the timing of the above signals. A clock signal S0 causes the free running counter 120 to generate a counter signal. The timer bus upstream the latch circuit 220 is provided with a signal S1. The timer bus downstream the latch circuit 220 is provided with a signal S2. When the capture conditions of all of the load input signals 101 to 104 are not satisfied, the signal S2 is maintained at a constant value. When the capture conditions of any one of the load input signals (e.g., load input signal 101) are satisfied, signal switching is performed in the timer bus.

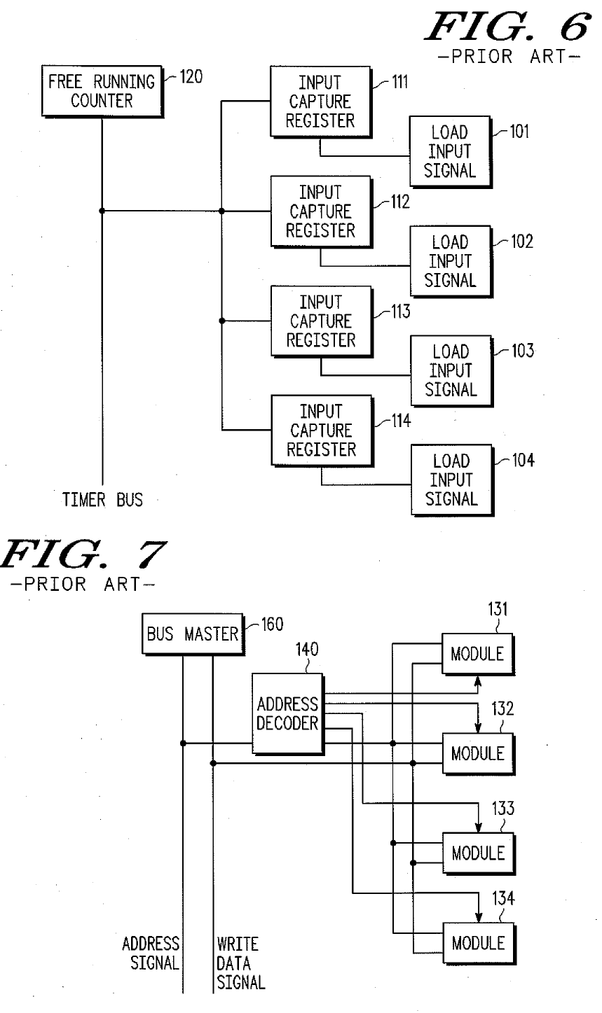

A circuit simulation was performed to compare the prior art structure of FIG. 6 with the structure of FIG. 1 (present invention). In this case, the measurement conditions were as described below.

Wire load: 200 fF

Frequency: 100 MHz

Bus switching percentage (bus switching activity): 50% (LSB), 0.0015% (MSB)

Load input signal switching percentage (load switching activity): 3.9%

In the simulation, the cell area of the present invention structure was 1.17 times greater than the prior art structure. However, the power consumption was reduced by about 71%.

The first embodiment has the advantages described below.

In the first embodiment, the latch circuit 220 is arranged in the bus. The latch circuit 220 is connected to the OR circuit 210, which receives the capture conditions of the load input signals 101 to 104. Thus, the input capture registers 111 to 114 are provided with the counter signal only when the capture conditions are satisfied. If the capture conditions are not satisfied, the latch circuit 220 does not switch the counter signal. This prevents unnecessary signal switching and reduces power consumption.

A second embodiment of the present invention will now be described with reference to FIGS. 3 and 4. In the second embodiment, a bus control system is applied to a circuit for use with an address bus or a write data bus. Here, a bus is hierarchized into n levels (in this embodiment, four levels), and a latch circuit is arranged in each hierarchical level.

In the second embodiment, a bus master 160, which serves as a signal providing means, provides a selection signal (signal indicating an activated state) to modules 131 to 134, which serve as units. Further, the modules 131 to 134 are respectively connected to latch circuits 331 to 334. An address decoder 330 provides each of the modules 131 to 134 with a selection signal, which is also provided to the latch circuits 331 to 334 that are respectively associated with the modules 131 to 134.

A latch circuit 321 is arranged in a bus connected to the hierarchical level (fourth level) block including the modules 131 to 134. Further, in this hierarchical level (third level), latch circuits 322 and 323 are arranged in buses connected to other blocks. An address decoder 320, which controls this hierarchical level block, provides the latch circuits 321 to 323 with selection signals of the blocks connected to the latch circuits.

Latch circuits 311 and 312 are arranged in buses for a second level, which is an upper rank level of the third level. An address decoder 310 selects the latch circuits 311 and 312. Further, a latch circuit 301 is arranged in a bus for a first level, which is an upper rank level of the second level. An address decoder 300 selects the latch circuit 301. In this embodiment, each address decoder functions as a detector.

In this manner, blocks including modules are divided into hierarchical levels, and each block is provided with a latch circuit. Further, each latch circuit is provided with an address decoder for selecting each hierarchical level block. This structure will now be discussed with reference to an address map 400, which is shown in FIG. 4. It will be assumed that addresses ADR_331 to ADR_334 are allocated to the modules 131 to 134, respectively. Address ADR_301 is allocated to the latch circuit 301 of the highest ranking hierarchical level. The bus for the latch circuit 301 is connected to the latch circuits 311 and 312 at addresses ADR_311 and ADR_312. Further, the bus for the latch circuit 311 is connected to the latch circuits 321 to 323 at addresses ADR_321 to ADR_323. The bus for the latch circuit 321 is connected to the latch circuits 331 to 334 at addresses ADR_331 to ADR_334.

The address decoders 300 to 330 each monitor bit data, which is included in an address signal at a predetermined position. Based on the bit data, the address decoders 300 to 330 specify the latch circuit that executes gate control.

The address decoders 300 to 330 are arranged in hierarchical levels and configured to provide each latch circuit with a selection signal. For example, if address ADR_331 is selected, the address decoders 300 to 330 select the latch circuits 301, 311, 321, and 331 to execute gate control. At the same time, gate control is not executed on the other latch circuits 312, 322, 323, 332, 333, and 334 and signal switching is not performed. Thus, the signal of a bus connected to modules is switched at the selected addresses.

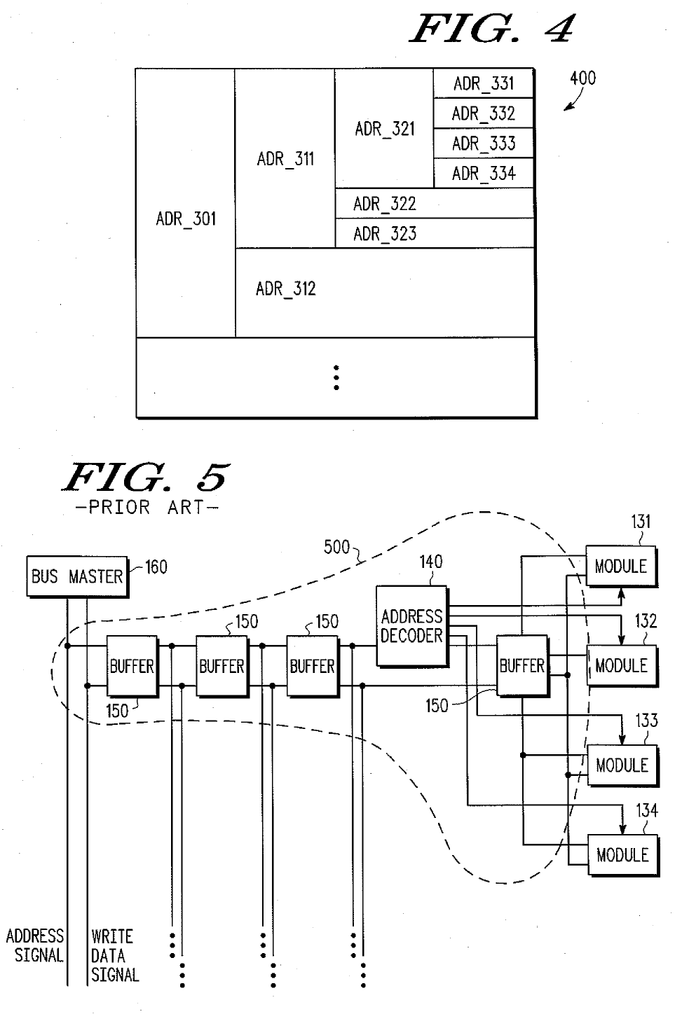

FIG. 5 shows a comparison circuit (prior art structure) including buffers 150 instead of latch circuits. A circuit simulation was conducted on region 500 of the comparison circuit and compared with the structure of FIG. 3 (present invention). In this case, the measurement conditions were as described below.

Wire load: 200 fF

Frequency: 100 MHz

Bus switching percentage (bus switching activity): 50%

In the simulation, the cell area of the present invention structure was 1.54 times greater than the prior art structure. However, the power consumption was reduced by about 17%.

The second embodiment has the advantages described below.

In the second embodiment, the addresses of modules are hierarchized, and a latch circuit is provided for each hierarchical block. Due to the latch circuits, signals are provided to buses for modules at designated addresses and not provided to other buses. That is, the address decoders and the latch circuits first divide a large address region into small hierarchized address regions. This prevents signals from being provided to modules that are not operating. Accordingly, unnecessary dispersion of signals is prevented, and power consumption is reduced.

It should be apparent to those skilled in the art that the present invention may be embodied in many other specific forms without departing from the spirit or scope of the invention. Particularly, it should be understood that the present invention may be embodied in the following forms.

In the first embodiment, the latch circuit 220 may be arranged between a timer bus and an input capture register. The quantity of the latch circuit 220 is not limited. When there are a plurality of input capture registers, a certain number of the input capture registers may be grouped together, and a latch circuit 220 may be provided for each one of such group of input capture registers. Although this would increase the number of latch circuits 220, dispersion of the counter signal for the timer bus would be prevented.

In the second embodiment, a latch circuit is provided for a bus grouped with a plurality of modules or blocks. However, a latch circuit does not have to be arranged in each hierarchical level and may be arranged in each group of a plural number of hierarchical levels.

In the second embodiment, a latch circuit is provided for each module. However, in the same manner as the first embodiment, a latch circuit may be provided for each group of a predetermined number of latch circuits. This reduces power consumption with a simpler structure.

The present examples and embodiments are to be considered as illustrative and not restrictive, and the invention is not to be limited to the details given herein, but may be modified within the scope and equivalence of the appended claims.

What is claimed is:

1. A bus control system for performing gate control, the bus control system comprising:
a bus for connecting a signal providing means with a unit;
a detection means for detecting an activated state of the unit; and
a latch means arranged in the bus between the signal providing means and the unit;
wherein the bus control system performs the gate control on the latch means based on the activated state of the unit detected by the detection means.

2. The bus control system according to claim 1, wherein the detection means detects the activated state of a plurality of units and outputs a logical disjunction of a signal indicating activation of the units.

3. The bus control system according to claim 1, wherein:
the signal providing means is a free running counter; and
the bus provides a counter signal of the free running counter to an input capture register.

4. The bus control system according to claim 1, wherein:
the signal providing means is a bus master;
the bus includes an address bus and a write data bus;
each unit has an address;
the address bus is connected to an address decoder serving as the detection means; and
the address decoder performs the gate control on the latch means arranged in the bus connected to the unit designated by an address signal.

5. The bus control system according to claim 4, wherein:
a plurality of units are grouped together so as to form a plurality of groups;
the bus is divided and connected to each group of units;
the latch means is arranged in each divided bus; and
the address decoder performs the gate control on the latch means arranged in the bus connected to the group including the unit designated by an address signal.

6. The bus control system according to claim 5, wherein the groups are hierarchized.
